(19) United States
(12) Patent Application Publication
(10) Pub. No.: US 2010/0111596 A1
(43) Pub. Date: May 6, 2010

(54) Vibration Damper Having a Fastening Cone

(75) Inventors: Günther Handke, Euerbach (DE); Manfred Schuler, Dittelbrunn (DE); Klaus Stretz, Hassfurt (DE); Josef Renn, Dettelbach (DE)

Correspondence Address: COHEN, PONTANI, LIEBERMAN & PAVANE LLP, 551 FIFTH AVENUE, SUITE 1210, NEW YORK, NY, 10176, US

(73) Assignee: ZF Friedrichshafen AG, Friedrichshafen (DE)

(21) Appl. No.: 12/593,757

(22) PCT Filed: Mar. 18, 2008
(86) PCT No.: PCT/EP2008/002135

§ 371 Date: Sep. 29, 2009

(30) Foreign Application Priority Data
Mar. 29, 2007 (DE) 10 2007 015 590.7

(51) Int. Cl. F16B 7/02

(52) U.S. Cl. 403/334

(57) ABSTRACT

A cylinder having an attachment on which a component having an internal taper surface is fixed, wherein in a positive anti-turning connection is in effect between the cylinder, and the taper connection has at least two regions in the circumferential direction having a smaller and a larger taper angle.

### PRIORITY CLAIM

This is a U.S. national stage of application No. PCT/EP2008/002135, filed on Mar. 18, 2008, which claims Priority to the German Application No.: 10 2007 015 590.7, filed: Mar. 29, 2007; the contents of both being incorporated herein by reference.

### BACKGROUND OF THE INVENTION

1. Field of the Invention

The present invention pertains to a vibration damper having an internal conical joint, configured for a positive, twist proof connection.

2. Prior Art

A vibration damper with a cylindrical tube, which comprises a conically shaped terminal area, to which a wheel carrier with an internal taper can be attached by a clamping screw is shown in FIG. 6 of GB 2 309 947 A1.

DE 82 32 408 U1, which represents a generic class of the device in question, shows a vibration damper and a wheel carrier, which are also clamped together by a conical joint. An anti-twist device is also implemented, which guarantees that the wheel carrier remains properly oriented in the circumferential direction.

A general problem of a conical joint is that, because the cone angle is relatively small, even very small deviations in the diameters lead to a certain axial displacement of the wheel carrier on the cylinder. As a result, these vibration dampers cannot be assembled in such a way that they always have the originally defined dimensions.

What seems at first glance to be an obvious solution is to use a simple axial stop, such as that disclosed in DE 198 15 215 A1. The problem here is that the axial stop and the cone cannot be aligned with respect to each other. As a result of this problem, either the axial stop has no effect or, because the wheel carrier is already resting against the axial stop, the conical joint does not transfer any clamping forces.

### SUMMARY OF THE INVENTION

A goal of the present invention is to realize a conical joint on a vibration damper which solves the axial positioning problem known from the prior art.

According to one embodiment of the invention, the conical joint comprises at least two adjacent areas in the circumferential direction, one with a smaller cone angle and one with a larger cone angle.

The smaller cone angle assumes the function of a friction-locking connection and the larger cone angle serves as a stop limit. As a result of the arrangement of the two different cone angles in the circumferential direction, an anti-twist function for the component to be held in place is also obtained.

So that a component to be held in place with a guide length that functions in a most effective way possible, at least one of the components to be connected comprises a concave conical surface.

To increase resistance to twisting, the fastening cone is designed with a cross section that is symmetrical to with respect a transverse axis.

Alternatively, the cylinder compromises at least two conical areas arranged in series in an axial direction. The at least two conical areas cooperate with two internal conical surfaces of the component to be held in place.

For the sake of an attachment which has as little play as possible and always remains at the proper angle, the angles of the internal conical surfaces of the component to be held in place and the angles of the conical areas of the cylinder are slightly different. Thus the angles of the internal conical surfaces of the component to be held in place deviate from the conical areas of the cylinder, which are the outward facing surfaces of the cylinder, such that a first internal cone angle is larger than the cooperating cone angle in the conical area of the cylinder, and a second internal cone angle is smaller than a cooperating second cone angle in the conical area of the cylinder. The result that it is the edges of the internal conical surfaces, which are the farthest apart, come to rest on the conical areas of the cylinder.

It is also possible for the internal conical surfaces to be convex in a direction toward the conical areas.

To avoid an undercut, that is, an increase in diameter between the internal conical surfaces, the radii of the internal conical surfaces are selected such that a tangent to the convex internal conical surfaces passes through a contact line formed at the transition between the two convex internal conical surfaces and is parallel to the center axis.

For the internal conical surface to be produced as easily as possible, the convex internal convex surface extends over both external conical surfaces. The wheel carrier is manufactured very easily by an appropriately ground drill or profiled milling tool.

Regardless of how the conical joint is designed, the cylinder is preferably provided with a marking that documents the position which the attached part assumes relative to the cylinder when the two components are assembled.

A device for preventing the component from being pulled off in the axial direction is provided by designing the cylinder so that it extends axially through the component to be held in place and by providing the cylinder with a projecting edge that is deformable in the radial direction.

To provide the conical joint with the greatest possible retaining force, the tangent to the smaller cone angle is smaller than the coefficient of friction of a pairing of lacquered metal surfaces.

### BRIEF DESCRIPTION OF THE DRAWINGS

The invention is to be explained in greater detail below on the basis of the following description of the figures:

FIG. 1 is a partial cross-section of a cylinder with a wheel carrier;

FIG. 2 is an end view of the cylinder of FIG. 1;

FIG. 3 is shows a side view of the cylinder of FIG. 1;

FIG. 4 a perspective view of the cylinder of FIG. 1;

FIG. 5 is a cylinder with a symmetrical design of the conical surfaces relative to a transverse axis;

FIG. 6 is a cylinder and a wheel carrier with two conical areas arranged in series in the axial direction,

FIG. 7 is an embodiment of the design with convex internal conical surfaces; and

FIGS. 8 and 9 show cylinders according to FIG. 6 with a convex internal conical surface.

### DETAILED DESCRIPTION OF THE DRAWINGS

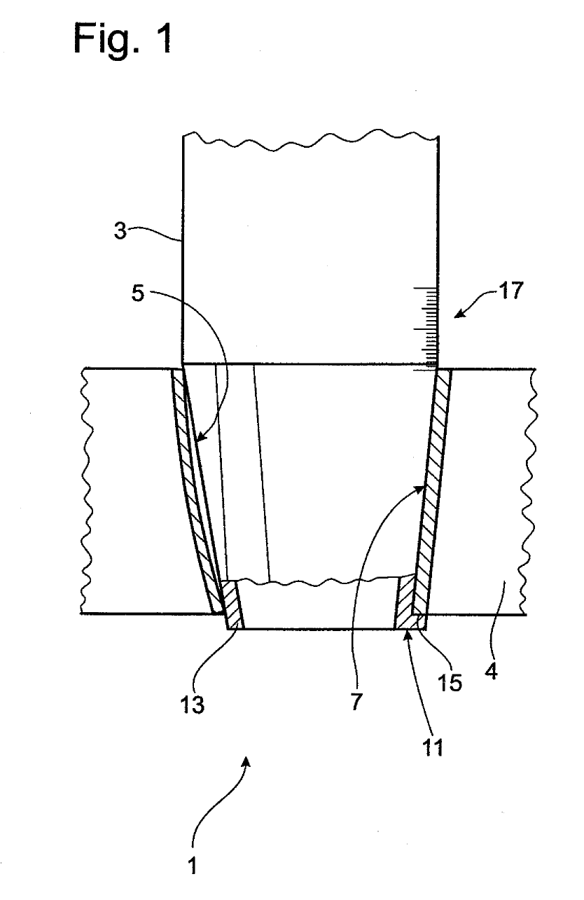

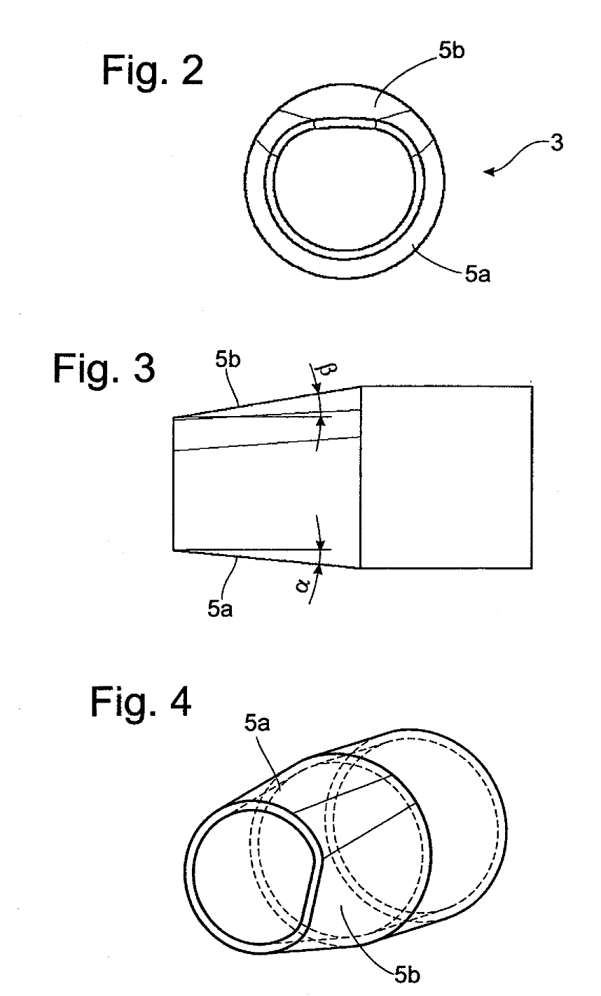

FIG. 1 is part of a vibration damper 1, depicting a cylinder 3 and a wheel carrier 4. As can be seen in FIGS. 1-4, the cylinder 3 has a fastening cone 5 that enters a nonpositive connection in the axial direction with an internal conical surface 7 of the wheel carrier 4. Based on the cylinder 3 and the fastening cone 5, FIGS. 2 and 3 show that the overall conical joint comprises at least two adjacent areas 5a, 5b in the circumferential direction with cone angles α and β of different sizes. A larger circumferential area 5a is designed with a smaller cone angle α than the second circumferential area 5b. As a result of the different cone angles on the fastening cones and on the internal cone, a positive, twist-proof connection is achieved between the wheel carrier 4 and the cylinder 3.

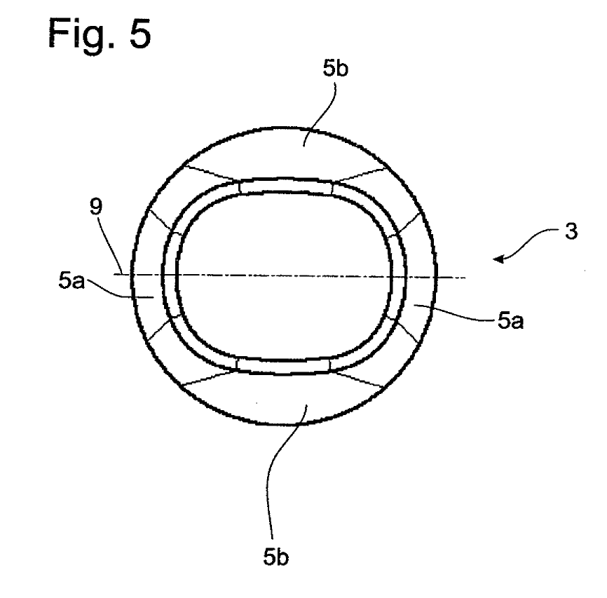

FIG. 5 comprises a fastening cone 5 with a cross section symmetric to a transverse axis 9; that is, opposing circumferential areas 5a, 5b are designed with the same cone angles α, β.

Preliminary tests have shown that a cone angle α of 3-6° is preferable for the larger circumferential area 5a and a cone angle β of 7-10° is preferable for the smaller circumferential area 5b. The larger circumferential area 5a, with the smaller cone angle α, forms the load-bearing connection between the cylinder 3 and the wheel carrier. The larger cone angle α, β ensures the axial positioning and the twist-proof function. An effective combination of the cone angles α, β and their dimensional tolerances, a double fit—that is, a dimensional agreement of the overall conical joint which would prevent the formation of a nonpositive connection on the large circumferential area 5a—is prevented.

To achieve a firmly seated conical joint, the smaller cone angle a comprises a tangent smaller than the coefficient of friction of a pairing of lacquered metal surfaces.

The left half of FIG. 1 shows that, on at least one of the two components to be connected, in this case the wheel carrier 4, a concave contour is provided. As a result, any dimensional deviations with respect to diameter and/or cone angle are compensated, so that the wheel carrier 4 has the longest possible guide length on the cylinder 3.

For assembly, the wheel carrier 4 is pressed axially onto the cylinder 3. As an axial pull-off prevention device 11, the cylinder 3 extends through the wheel carrier 4, as the component to be held in place, and a projecting edge 13 of the cylinder 3 can be deformed in the radially outward direction. The edge 13 or a section of the edge 13 will then rest against an end surface 15 of the wheel carrier 4.

FIG. 1 also shows a marking 17 as an additional feature, which documents the axial position which the wheel carrier 4 assumes during the assembly process. When the vibration damper is subjected to a load beyond its planned limit as a result of an extreme inward deflection, the cylinder 3 can, under certain circumstances, be pressed farther into the wheel carrier 4. This axial displacement can be determined on the basis of the marking 17, so that, during a vehicle inspection, it is possible to see if the vibration damper has been overloaded.

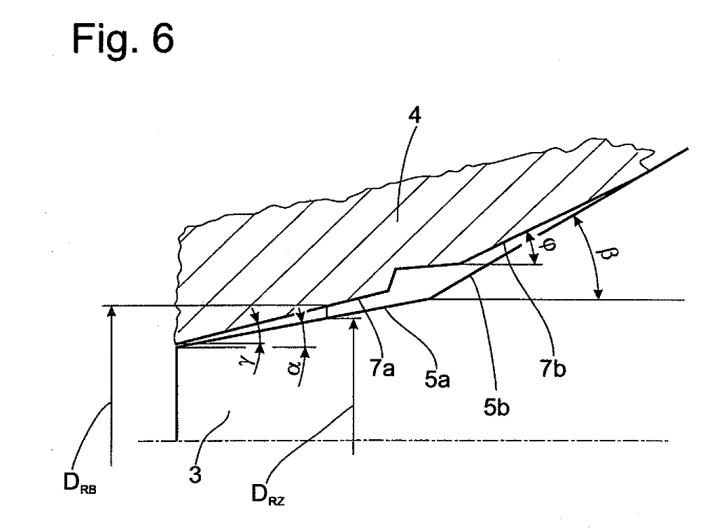

FIG. 6 shows a cylinder 3 with at least two conical areas 5a, 5b arranged in series in the axial direction, which comprise different cone angles φ, β. The wheel carrier 4 also has two internal conical surfaces 7a, 7b, arranged in series, with different cone angles γ, φ, wherein the conical areas 5a, 7a on the cylinder and on the wheel carrier 4 with the smaller cone angle form the nonpositive conical connection, and the conical areas 5b, 7b with the larger cone angle maintain the axial position of the wheel carrier 4 versus the cylinder 3 within a narrow range of tolerances.

The axially overlapping cone angles on the wheel carrier 4 and on the cylinder 3 are designed with a defined deviation. The angles γ, φ of the internal conical surfaces 7a, 7b of the wheel carrier deviate, relative to a defined diameter D_{RB} on the wheel carrier and D_{RZ} on the cylinder, from the cone angles α, β of conical areas 5a, 5b of the cylinder 3 in such a way that a first internal cone angle γ is larger than the cooperating first cone angle α in the first conical area 5a of the cylinder 3, and a second internal cone angle φ is smaller than the second cone angle β in the conical area 5b of the cylinder 3, so that the edges of the internal conical surfaces 7a, 7b which are the farthest apart come to rest on the conical areas 5a, 5b of the cylinder 3. Thus a play-free and rattle-free connection is guaranteed between the wheel carrier 4 and the cylinder 3.

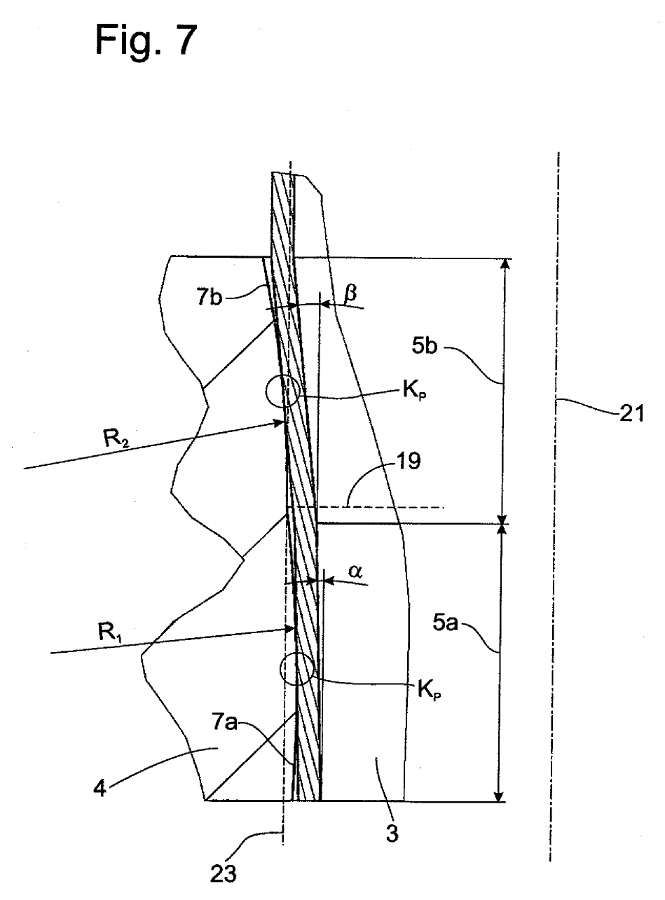

FIG. 7 shows a variant, which builds on that of FIG. 6. The internal conical surfaces 7a, 7b of the wheel carrier 4 are designed with a convexity toward the conical surfaces 5a, 5b of the cylinder 3 and have different radii of curvature R₁, R₂. The load-bearing contact points K_{P} of the internal conical surfaces 7a, 7b are marked by circles. A contact line 19 is formed at the transition between the two convex internal conical surfaces 7a, 7b. The radii of the internal conical surfaces 7a, 7b are selected so that a tangent 23 to the internal conical surface 7b through the contact line and parallel to the center axis 21 of the cylinder 3 extends so that there is no undercut anywhere over the course of the two internal conical surfaces 7a, 7b.

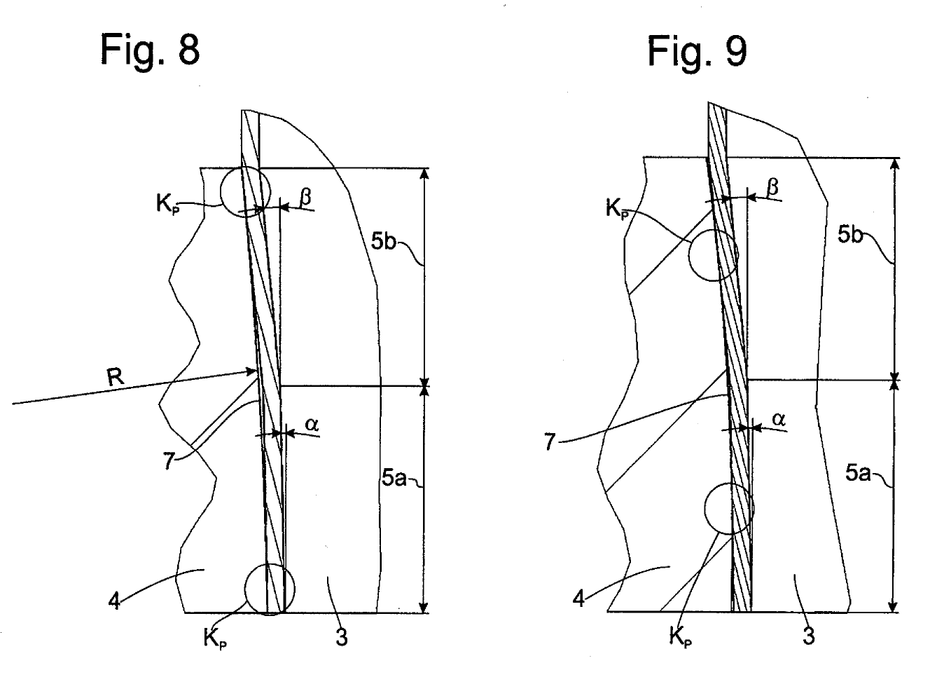

FIGS. 8 and 9 show a conical joint with two conical areas 5a, 5b with different angles α, β, arranged in series. In FIG. 8, the angles are shown to scale 0.5° below the nominal dimension of α=5° and β=7°. The convex internal conical surfaces is oriented toward the conical surfaces 5a, 5b. The radius was selected so that the contact points K_{P} between the internal conical surface 7 and the conical surfaces 5a, 5b lie directly in the outer boundary area of the conical joint.

FIG. 9 shows the angles α, β increased by 0.5° , whereas the radius R of the internal conical surface 7 is kept the same. The contact points inside the conical joint are a sufficient axial distance apart to ensure that a slanted position does not occur and no wobbling is possible. As can be seen, there is practically no axial offset between the height of the cylinder 3 and that of the wheel carrier 4.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-11. (canceled)

12. A cylinder comprising:
a fastening cone surface configured to hold a component with an internal conical surface in place with a positive, twist-proof connection, the fastening cone surface configured as a conical joint comprising:
a first area in the circumferential direction having a first cone angle; and
a second area in the circumferential direction having a second cone angle,
wherein the first cone angle is smaller than the second cone angle.

13. The cylinder according to claim 12, wherein at least one of the fastening cone surface and the internal conical surface is a concave conical surface.

14. The cylinder according to claim 12, wherein the fastening cone surface is symmetric in cross section to a transverse axis of the fastening cone surface.

15. The cylinder according to claim 12, wherein the fastening cone surface comprises at least two conical areas arranged in series in an axial direction, each of the at least two conical areas arranged in series having a respective conical angle configured to mate with the component, the internal conical surface of the component having corresponding conical areas with internal cone angles in the axial direction.

16. The cylinder according to claim 15, wherein internal cone angles of the conical area of the internal conical surface deviate from the respective conical angles of the cylinder such that a first internal cone angle of the internal cone angles is larger than the cooperating cone angle in the conical area of the fastening cone surface and a second internal cone angle of the internal cone angles is smaller than a cooperating second cone angle in the conical area of the cylinder,
wherein the edges of the conical areas of the internal conical surfaces that are farthest apart rest on respective areas of the conical areas of the cylinder.

17. The cylinder according to claim 15, wherein the conical areas of the internal conical surface are convex toward the conical areas of the component.

18. The cylinder according to claim 17, wherein a tangent to the convex conical areas of the internal conical areas of the conical surface through a contact line formed at a transition between the two convex internal conical surface is parallel to the center axis.

19. The cylinder according to claim 17, wherein the convex internal conical surface extends over the at least two conical areas of the fastening cone surface.

20. The cylinder according to claim 12, wherein the cylinder further comprises at least one marking configured to indicate a position of the component with respect to the cylinder.

21. The cylinder according to claim 12, wherein the cylinder extends axially through the component and a projecting edge of the cylinder is radially deformable to form an axial pull-off prevention device.

22. The cylinder according to claim 18, wherein the tangent to the smaller cone angle is smaller than a coefficient of friction of a pairing of lacquered metal surfaces of the respective cylinder and component.

23. The cylinder according to claim 12, wherein the first and second cone angles are about 3°-6° and 7°-10°, respectively.

24. The cylinder according to claim 12, wherein the cylinder is a cylinder of a vibration damper and the component is a wheel carrier.

25. The cylinder according to claim 24, wherein the cylinder further comprises at least one marking configured to indicate a position of the component with respect to the cylinder, wherein a determination of whether the vibration dampers has been overloaded during use can be made based on inspection of the portion.
